(19) United States
(12) Patent Application Publication
(10) Pub. No.: US 2006/0272900 A1
(43) Pub. Date: Dec. 7, 2006

(54) Lubricant change system

(75) Inventor: Douglas O. Clyne, Yale, MI (US)

Correspondence Address: REISING, ETHINGTON, BARNES, KISSELLE, P.C., P O BOX 4390, TROY, MI, 48099-4390, US

(73) Assignee: The Detroit Edison Company

(21) Appl. No.: 11/146,465

(22) Filed: Jun. 7, 2005

(51) Int. Cl. F16N 7/24

(52) U.S. Cl. 184/15.1

(57) ABSTRACT

A lubricating oil change system for the roll wheel bearings of a coal pulverizer in which old lubricating oil is withdrawn from the bearings by a suction pump and new lubricating oil is introduced to the bearings by a second pump during continuous operation of the coal pulverizer. Alternatively, the lubricating oil may be withdrawn from the bearings and passed through a filter and then returned to the bearings.

### FIELD OF THE INVENTION

This invention relates generally to lubricant change systems and more particularly to a lubricant change system for the bearings of the mill roll wheels in a coal pulverizer.

### BACKGROUND OF THE INVENTION

Industrial coal pulverizers of the roll-and-race type typically have roll wheels which bear on a rotating track to grind and pulverize coal for use in the boilers of an electric power plant.

However, the lubricant (oil) in the roll wheel bearings needs to be changed from time to time, usually at least once in every 3000-5000 hours of operation. At the present time, it is necessary to shut down the entire coal pulverizer to change the oil. The average down time for an oil change is 8-12 hours. Shutting down the pulverizer is very costly because there is a loss of approximately 50-100 megawatts of power for each hour that the pulverizer is down.

### SUMMARY OF THE INVENTION

In accordance with the present invention, it is not necessary to shut down the pulverizer for a change of lubricating oil. The lubricating oil in the wheel bearings can be changed while the pulverizer is running. To accomplish this, two conduits or pipes, preferably one within the other, are connected to the lubricating oil reservoir for the bearings of each roll wheel. When it is time for a change of lubricating oil, the used lubricating oil is withdrawn from the bearings through one pipe and, when most of the used lubricating oil has been withdrawn, fresh lubricating oil is introduced into the bearing through the other pipe. The pulverizer may continue to operate normally throughout the complete oil change.

Alternatively, the used lubricating oil withdrawn through one pipe may be delivered to a filter where impurities are removed to restore the lubricating oil for reuse, and the restored lubricating oil is returned to the bearings through the other pipe. The filtration may continue through several cycles, continuously withdrawing the lubricating oil for filtering and routing the filtered lubricating oil back to the bearings. This alternative method can also be carried out while the pulverizer is running, requiring no shut down whatsoever.

One object of this invention is to provide a lubricant change system for a coal pulverizer having the foregoing features and capabilities.

Another object is to provide a lubricant change system which is rugged and durable in use, is composed of a relatively few simple parts, and is easy to operate and inexpensive to manufacture and install.

Other objects, features and advantages will become apparent as the following description proceeds, especially when considered with the accompanying drawings.

### BRIEF DESCRIPTION OF THE DRAWINGS

FIG. 1 is a sectional view of a coal pulverizer constructed in accordance with the invention.

FIG. 2 is an enlarged sectional view with parts in section showing one of the mill roll wheels seen in FIG. 1;

FIG. 3 is a perspective view showing apparatus for use with the coal pulverizer of FIG. 1 to change the lubricating oil in the bearings of the roll wheels;

FIG. 4 is a perspective view similar to FIG. 3 but showing an oil change apparatus of modified construction;

### DETAILED DESCRIPTION OF THE PREFERRED EMBODIMENTS

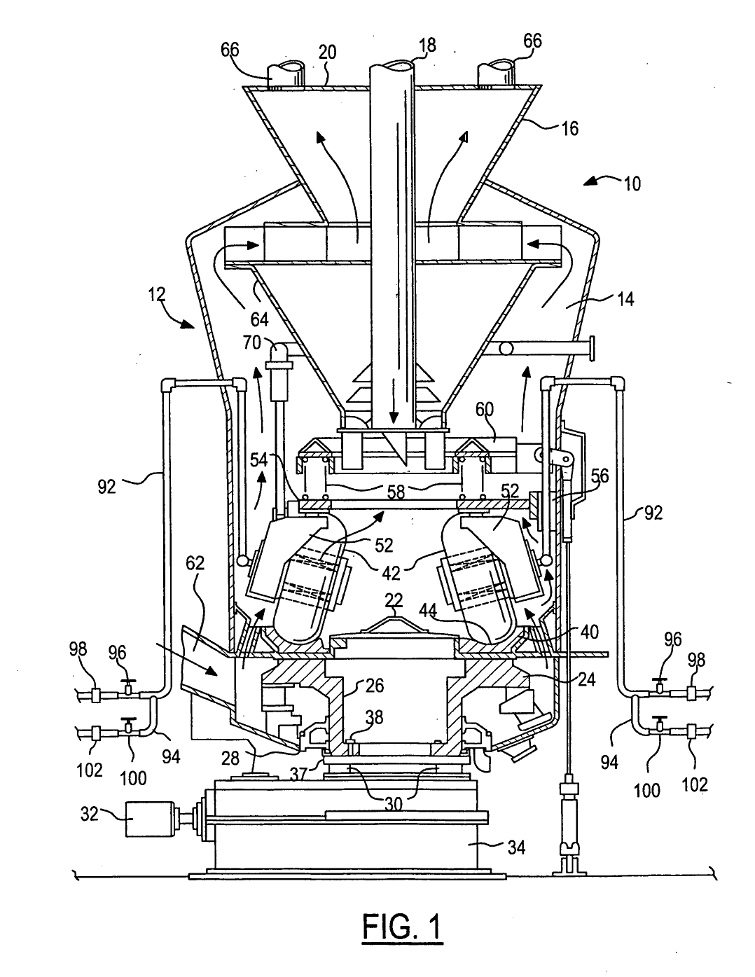

Referring now more particularly to the drawings and especially to FIGS. 1-3, a coal pulverizer 10 is shown, comprising a housing 12 forming a chamber 14 in which coal is pulverized for use in the boiler of an electric power plant. The housing has a burner line bonnet 16 at the top. A vertical coal downspout 18 extends through the top plate 20 of the bonnet. Raw coal admitted through the open upper end of the downspout is discharged onto a dome-shaped cover cone 22 of a yoke 24.

The yoke 24 has a lower extension 26 which extends down through a central opening 28 in the bottom of the housing 12 and is supported for rotation on a vertical axis coinciding with the vertical centerline of the housing. The yoke 24 is supported for rotation by bearings 30.

The yoke is rotated by a motor 32. More specifically, the motor 32 has an output shaft extending into a gear box 34 and is geared to a vertical shaft. The shaft is secured to a plate 37 which is secured to the bottom of the yoke by fasteners 38.

The yoke has an annular ring 40 surrounding the cover cone 22. Free turning roll wheels 42 engage the concave top surface 44 of the ring 40 to pulverize coal that has been dropped on the cover cone and diverted radially outwardly onto the ring 40. The roll wheels are mounted for free rotation in journal housings 52 that are installed beneath a pressure frame 54. The pressure frame 54 is mounted for vertical sliding movement by frame supports 56 secured to the housing and are pressed downwardly by compression springs 58 carried by a spring frame 60 suitably secured within the housing.

Hot air enters the housing through an air inlet 62 and rises upwardly, following the path of the arrows. The rising air passes through the cone classifier 64 and out through burner lines 66 leading to a boiler burner deck. The flow of air carries with it the fine coal pulverized by the roll wheels. A seal air header 70 in the coal pulverizer housing directs seal air to the journal housings of the roll wheels.

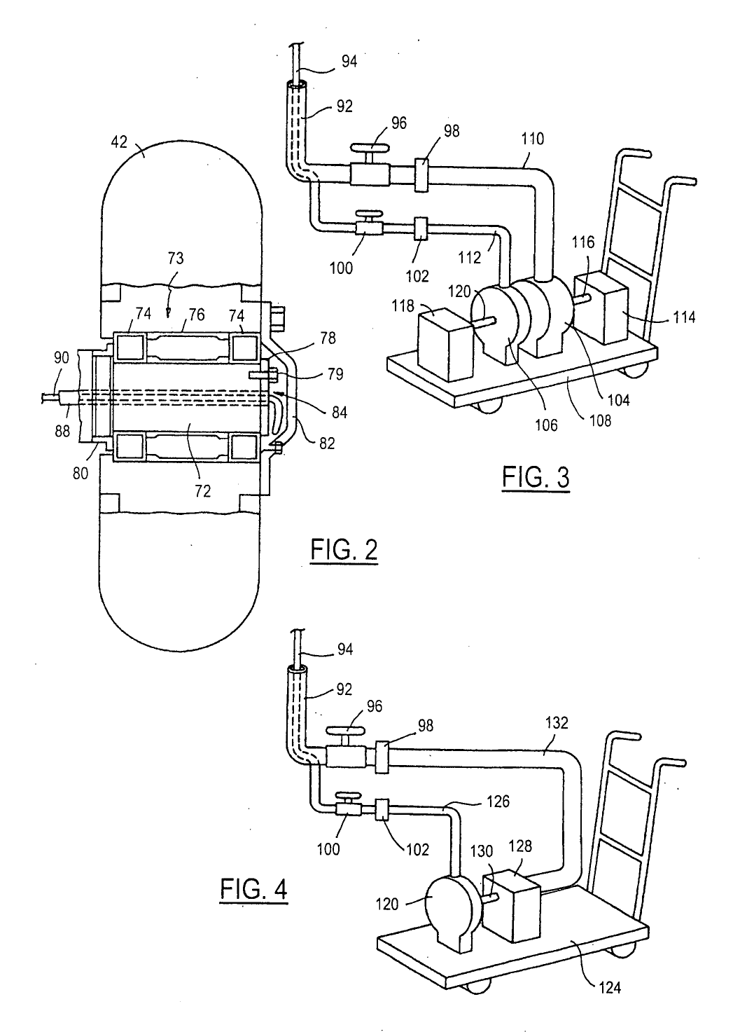

All of the roll wheels 42 are of the same construction shown in FIG. 2. As they are shown, the roll wheel 42 is mounted on a shaft 72 carried by one of the journal housings 52. The roll wheel 42 is mounted on the shaft 72 for rotation by a bearing assembly 73 including two roller bearings 74 which encircle the shaft and are spaced apart by a spacer 76. The bearing assembly 73 is axially positioned between a retainer plate 78 secured on the shaft 72 by fasteners 79 at one end of the bearing assembly, and a retainer ring 80 secured to the shaft 72 at the opposite end of the bearing assembly. A cap 82 is secured to the end of the shaft 72. The cap 82 and ring 80 provide a closed reservoir 84 for lubricating oil which keeps the bearings lubricated.

Extending through the shaft 72 and through the plate 78 is a relatively large diameter, tubular oil fill pipe 88 for introducing lubricating oil into the oil reservoir 84. Extending lengthwise within the oil fill pipe 88 is a relatively small diameter, tubular oil suction pipe 90 for withdrawing lubricating oil from the oil reservoir 84. The two pipes have pipe extensions 92 and 94 which extend outside the housing 12. The pipe extension 92 has a shut-off valve 96 and a coupling 98. The pipe extension 94 has a shut-off valve 100 and a coupling 102. The pipes and pipe extensions form part of an oil change system which will now be described.

Referring to FIG. 3, the oil change system comprises oil pumping apparatus including an oil pressure pump 104 and an oil suction pump 106, both mounted on a wheeled cart 108. A pipe 110 extends from the pressure pump 104 and is adapted to be attached to the pipe extension 92 by the coupling 98. A pipe 112 extends from the suction pump 106 and is adapted to be attached to the pipe extension 94 by the coupling 102. The pressure pump 104 draws lubricating oil from an oil can 114 through a conduit 116. The suction pump 106 is connected to an oil collector 118 by a conduit 120.

In use, and when it is time for an oil change, the cart 108 is moved to a position adjacent to one of the roll wheels, the pipe 110 from the pressure pump 104 is attached to the pipe extension 92 by the coupling 98 and the pipe 112 from the suction pump 106 is attached to the pipe extension 94 by the coupling 102. The shut-off valve 100 is opened. The suction pump 106 is then operated to withdraw old lubricating oil from the oil reservoir 84 through the pipe 90, the pipe extension 94 and the pipe 112, and discharge it into the oil collector 118. After a portion of the old oil is withdrawn from the oil reservoir 84, the shut-off valve 96 is opened. The pressure pump 104 is operated to withdraw new lubricating oil from the oil container 114 and deliver it to the oil reservoir 84 through the pipe 110, the pipe extension 92 and the pipe 88. At the same time the remaining old oil is withdrawn and an equal amount of new oil is added. After the oil reservoir 84 of one of the roll wheels is filled with new oil, the oil change is completed. The shut-off valves 96 and 100 are closed and the pipes 110 and 112 from the pumps are uncoupled from the pipe extensions 92 and 94. The cart may then be moved to a position adjacent to another of the roll wheels where the oil change procedure can be repeated. The oil change is made quickly and with no shut down whatever of the coal pulverizer being required.

Referring to FIG. 4, an oil change system of modified construction is shown. The oil change system in FIG. 4 includes an oil pump 120 mounted on a wheeled cart 124. A pipe 126 extends to the suction side pump 120 and is adapted to be attached to the pipe extension 94 by the coupling 102. An oil filter 128 is mounted on the cart to filter and recondition used or old oil and make it like new. The oil filter 128 is connected to the pressure side of pump 120 by a conduit 130 providing an inlet connection to the filter. The filter 128 is connected to a pipe 132 which provides an outlet connection from the filter that is adapted to be connected to the pipe extension 92 by the coupling 98.

In use, and when it is time for an oil change, the cart 124 is moved to a position adjacent to one of the roll wheels, the pipe 126 to the pump 120 is attached to the pipe extension 94 by the coupling 102 and the pipe 132 from the oil filter 128 is attached to the pipe extension 92 by the coupling 98. Both shut-off valves 96 and 100 are opened. The pump 120 is then operated. Old lubricating oil is withdrawn from the oil reservoir 84 through the pipe 90, the pipe extension 94 and the pipe 126, and pumped into the filter 128 by the pump 120. Filtered lubricating oil is then passed through the filter 128 and delivered back to the oil reservoir 84 through the pipe 132, the pipe extension 92 and the pipe 88. The withdrawal of the old oil, filtering of the old oil and then returning it in a filtered condition to the oil reservoir 84 continues until it is determined that all of the old oil has been sufficiently filtered to remove impurities and restore it to a condition suitable for continued use. The withdrawing of the lubricating oil through the pipe 90, the pipe extension 94 and the pipe 96 continues simultaneously with the returning of the filtered lubricating oil through the pipe 132, the pipe extension 92 and the pipe 88. Upon completion of the filtering process for one of the roll wheels, the shut-off valves 96 and 100 are closed, and the pipes 126 and 132 are uncoupled from the pipe extensions 92 and 94. The cart may be moved to a position adjacent to another of the roll wheels where the oil filtering procedure can be repeated. The filtering of the oil is carried out quickly and requires no shut down of the coal pulverizer.

1. A lubricating oil change system for roll wheel bearings of a coal pulverizer, comprising:
a first pipe leading to the bearings,
a second pipe leading to the bearings, and
oil pumping apparatus for withdrawing lubricating oil from the bearings through the first pipe and introducing lubricating oil into the bearings through the second pipe.

2. The lubricating oil change system of claim 1, wherein said oil pumping apparatus includes a first pump for withdrawing lubricating oil from the bearings through the first pipe and a second pump for introducing lubricating oil into the bearings through the second pipe.

3. The lubricating oil change system of claim 2, further including a collector to receive and collect from the first pipe the lubricating oil withdrawn from the bearings.

4. The lubricating oil change system of claim 2, wherein one of the pipes extends lengthwise within the other of said pipes.

5. The lubricating oil change system of claim 2, wherein the first pipe extends lengthwise within the second pipe.

6. The lubricating oil change system of claim 5, further including a collector to receive and collect from the first pipe the lubricating oil withdrawn from the bearings.

7. The lubricating oil change system of claim 1, further including a lubricant filter, an inlet connection from the first pipe to the filter to deliver the lubricant withdrawn from the bearings to the filter for filtration, and an outlet connection from the filter to the second pump to deliver to the second pump the lubricant filtered by the filter.

8. The lubricating oil change system of claim 6, further including an oil container for new lubricating oil, and a conduit from said oil container to the second pump such that the new lubricating oil will be introduced into the bearing.

9. The lubricating oil change system of claim 6, wherein the first pipe extends lengthwise within the second pipe.

10. A method of changing lubricating oil in a roll wheel bearings of a coal pulverizer while the coal pulverizer is running, comprising:
providing first and second pipes leading to the bearings,
withdrawing used lubricating oil from the bearings through the first pipe, and
after at least a portion of the used lubricating oil has been withdrawn from the bearings, introducing fresh lubricating oil into the bearings.

11. The method of claim 10, wherein one of the pipes extends lengthwise within the other of said pipes.

12. The method of claim 10, wherein the first pipe extends lengthwise within the second pipe.

13. A method of changing lubricating oil in roll wheel bearings of a coal pulverizer while the coal pulverizer is running, comprising:
providing first and second pipes leading to the bearings,
withdrawing lubricating oil from the bearings through the first pipe,
delivering the lubricating oil withdrawn from the bearings to a filter,
filtering the lubricating oil in the filter, and
returning the filtered lubricating oil to the bearings through the second pipe.

14. The method of claim 13, wherein the withdrawing of the lubricating oil from the bearings through the first pipe continues simultaneously with the returning of the filtered lubricating oil to the bearings through the second pipe.

15. The method of claim 14, wherein one of the pipes extends lengthwise within the other of said pipes.

16. The method of claim 14, wherein the first pipe extends lengthwise within the second pipe.
